(19) United States
(12) Patent Application Publication
(10) Pub. No.: US 2008/0035224 A1
(43) Pub. Date: Feb. 14, 2008

(54) Sleeved spool fluid power control valve

(76) Inventor: Robert Clark Tyer, Jacksonville, FL (US)

Correspondence Address: ROBERT CLARK TYER, 12794 BURNING TREE LANE W., JACKSONVILLE, FL, 32223, US

(21) Appl. No.: 11/810,197

(22) Filed: Jun. 4, 2007

Related U.S. Application Data
(60) Provisional application No. 60/811,381, filed on Jun. 6, 2006.

(51) Int. Cl. F16K 1/44

(52) U.S. Cl. 137/625.34

(57) ABSTRACT

The Sleeved Spool Fluid Power Control Valve uses the longitudinal movement of a sleeved spool to open and close the fluid inlet and exhaust ports in a valve body. The sleeve that surrounds the spool is integral with the spool. The longitudinally ported sleeve traverses the valve bore and always maintains contact with the sealing mechanisms. This provides for greatly extended seal life in high cycle valve applications such as found in a pneumatic pile driving hammer, where cycles of 60 per minute and more are common with air flows of 250 cfm and higher.

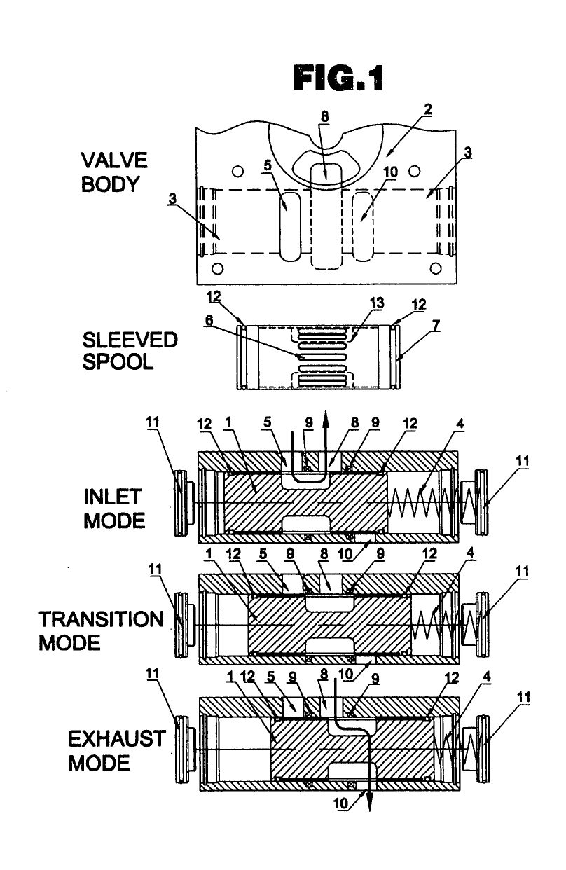

### RELATED APPLICATION

This application is a continuation of provisional application Ser. No. 11/810,197 filed on Jun. 06, 2007 which is incorporated in it's entirety by reference.

### BACKGROUND OF THE INVENTION

Fluid power control through the use of poppet valves has been used for applications such as but not limited to pneumatic pile driving hammers. This type of application demands high fluid flows under pressure, rapid on/off cycles of up to and in excess of 60 valve shifts per minute. Unfortunately, the conventional poppet valve has a spool to valve bore configuration that necessitates the seating and unseating of the spool seal mechanism with each traversal (shift) of the spool. The seating of the spool on to the seal produces a shearing force that is magnified under high cycling such as found in a pneumatic pile driving hammer application. Furthermore, the poppet valve allows some pressurized fluid to escape to exhaust or atmosphere as it shifts from “inlet” mode to “exhaust” mode. This is a loss of energy needed for the optimum function of an actuator and also causes excessive heat generation. The sleeved spool fluid power control valve eliminates many problems inherent with conventional poppet valves. It maintains continuous spool contact with it's sealing mechanism. It does not allow the loss of pressurized fluid to exhaust during shifting and is consequently very energy efficient.

### SUMMARY OF THE INVENTION

The present invention is premised on the realization that in fluid power valve applications long seal service life under high cycle applications can be attained only when the sealing mechanism stays in continuous contact with the shifting spool. The sleeved spool design keeps continuous contact with the sealing mechanism in the valve bore during the full longitudinal traversing of the spool in the valve bore. Furthermore, the present invention has a high flow capacity in relation to it's physical size when compared to conventional poppet valves. The present invention requires minimal pilot pressure for shifting; it also requires very minimal lubrication. This minimal lubrication requirement is ideal for pneumatic applications, especially when working in environmentally sensitive areas and exhaust air is discharged into the atmosphere. The sleeved spool design has positive on/off characteristics so that there is no energy loss to atmosphere/exhaust during the shifting cycles.

### BRIEF DESCRIPTION OF THE DRAWING

The FIGURE is a diagrammatic depiction of the apparatus and the method in which it functions.

Shown are:
The valve body with porting and the bore to accept the sleeved spool.
The sleeved spool with the longitudinal ports.
The sleeved spool In the inlet mode showing the position of the sleeved spool and corresponding port alignment.
The sleeved spool in the transition mode showing the position of the sleeved spool and corresponding un-alignment of the ports.
The sleeved spool in the exhaust mode showing the position of the spool and corresponding port alignment.

### DETAILED DESCRIPTION

Inlet Mode

The sleeved spool 1 consisting of an assembly made up of a spool 13 and a sleeve 7 is sealed on both ends with “O” rings 12 to prevent fluid leakage from the sleeved spool 1. The sleeved spool 1 is contained within the valve body 2, bore 3 and is spring 4 loaded to be in the inlet mode.

Pressurized fluid enters the valve body inlet port 5. At this time the longitudinal ports 6 of the sleeve 7 are in alignment with the valve body inlet port 5 and the valve body port 8.

During this mode of the valve cycle and all subsequent sleeved spool 1 shifts there exists continuous contact and sealing pressure on the lip type seals 9.

Furthermore, during the complete shifting cycle from inlet mode through transition mode to exhaust mode; there is no loss of pressurized fluid to atmosphere or reservoir, etc.

Transition Mode

The sleeved spool 1 is stationary only in either inlet mode or exhaust mode. The transition mode is actually a method of depicting the closure of all ports 5, 8, 10 during a split second of time that the sleeved spool 2 takes to traverse the valve body bore 3 from one spool cap 11 to the other spool cap 11.

Exhaust Mode

Control fluid pressure pushes the sleeved spool 1 against the spring 4 and causes the sleeved spool 1 to shift to the exhaust mode. At this time the sleeve 7 longitudinal ports 6 are aligned with the exhaust port 10.

This apparatus has many advantages over conventional poppet valves such as long seal life, high flow capacity to physical size, compactness, tolerance of high duty cycles of 60+ shifts per minute and no fluid power loss to atmosphere or reservoir during shifting from inlet mode to exhaust mode, through transition mode, to exhaust mode and back.

I claim:

1. An apparatus for controlling the flow of a fluid under pressure that embodies a sleeved spool within a valve body, said sleeve has longitudinal ports.

2. An apparatus for controlling the flow of a fluid under pressure embodying a sleeved spool that maintains continuous seal contact and pressure at all times during any and all traversals or shifts including all sleeved spool positions.

3. An apparatus for controlling the flow of a fluid under pressure that has positive on-off flow characteristics. There exists no fluid loss as valve moves from a power mode to an exhaust mode as it (sleeved spool) passes over center between the valve body ports.
